(19) United States
(12) Patent Application Publication
(10) Pub. No.: US 2019/0210386 A1
(43) Pub. Date: Jul. 11, 2019

(54) AN INKJET PRINTING METHOD

(71) Applicants: Yuan CHANG, Beijing (CN); BEIJING MEIKEYI CO., LTD, Beijing (CN)

(72) Inventor: Yuan Chang, Newtown Square, PA (US)

(21) Appl. No.: 16/337,907

(22) PCT Filed: Jun. 2, 2017
(86) PCT No.: PCT/CN2017/086903

§ 371 Date: Mar. 28, 2019

(51) Int. Cl. B41J 25/00; B41J 25/304; B41J 2/21

(52) U.S. Cl. CPC B41J 25/006; B41J 2/2103; B41J 25/304

(57) ABSTRACT

The present invention provides an inkjet printing method, wherein includes the print heads' left and right scan movement along the scanning direction (X direction), the print heads' step movement along the step direction (Y direction), and the print heads' vertical movement perpendicular to the platen on which the to-be-printed object is placed (Z direction). The print heads jet ink during scanning movement for Bidirectional printing or Unidirectional printing. The print heads do not jet ink during step movement or vertical movement. The characteristic is, the step distance SH of the print heads in the step movement is a tiny step SH distance, which satisfies SH≤(HH−H)/Steps (the calculation of “HH−H” divided by the number of steps, the unit can be millimeter), wherein “HH” represents the total print swath height of one or more print heads(stitched), “H” represents the height of the to-be-printed image area, and “Steps” represents step times. This method realizes printing of high-resolution image pattern using the print heads of relatively low-resolution. It enables to reduce the total step times of the print heads and improves the utilization ratio of head nozzles. Thus, on the premise of guaranteeing the high-resolution, the print time is shortened and the printing efficiency is improved.

### FIELD OF THE INVENTION

The invention relates to an inkjet printing method, more particularly to a printing method adopting a tiny step mode of one or more print heads to reduce the print heads' scanning times.

### BACKGROUND OF THE INVENTION

Inkjet printing is a technology in which the print heads jet ink to the object to generate image pattern. It is a non-contact printing and widely used in the industrial application field with advantages such as high print speed, low pollution and good adaptability to multiple types of objects. The inkjet printing is divided into Scanning inkjet printing and Single-pass inkjet printing according to the motion mode of carriage and to-be-printed object. Scanning inkjet printing adopts step movement of the print heads (multi-pass printing) to improve the desired resolution of image pattern. During scanning inkjet printing, the printing carriage scans left and right along the linear guide beam/the scanning direction and relatively steps along the step direction perpendicular to the linear guide beam. For single-pass inkjet printing, the carriage stays still and the object moves in high speed unidirectionally. Single-pass inkjet printing has a high demand for print resolution and print height of the print heads. The head resolution should be equal to the desired resolution of the image pattern, and the print height of head should be equal to the height of the to-be-printed image area. Of course the high precision can be also obtained by head stitching and the print height can be also increased by installing head in series. However, this method requires more heads. The cost of printer will be increased by either using the high-resolution head or using multiple heads to obtain high print precision.

For scanning inkjet printing, the low-resolution print heads can be used and the desired resolution of the to-be-printed image pattern can be improved by the step movement of the print heads (multi-pass printing). This method can cut the cost of printing apparatus and reduce the demand for head resolution.

In the present technology, there are two types of image size. The first one, as shown in FIG. 1, the height of the to-be-printed image area “H” is larger than the total print swath height of one or more print heads(stitched) “HH”. Take scanning for 4 times (4 Pass printing) as an example, which means improving the desired print resolution to four times of the head resolution: divide the head nozzles into four sections, and the height of each section is HH/4. The print head steps a distance of HH/4 in each step process. At the beginning of printing, the print head is at the position S1 in the step direction. The print head scans left and right along the scanning direction. During the unidirectional printing, the head nozzles in shaded area jet ink to generate image pattern when passing the to-be-printed image area. After coming back to the start edge in the scanning direction, the print head steps a distance of HH/4 along the step direction and reaches the position S2 in the step direction. The print head scans left and right along the scanning direction. The head nozzles in shaded area jet ink to generate image pattern by the unidirectional printing method when passing the to-be-printed area. After coming back to the start edge in the scanning direction, the print head steps a distance of HH/4 again along the step direction and reaches the position S3 in the step direction, and so on. When the whole print head enters to the to-be-printed image area, all head nozzles jet ink. When printing the third pass from the end (the third scanning from the end), the top ¼ section of the print head moves out of the to-be-printed image area. The print head scans left and right along the scanning direction. The head nozzles in shaded area (the bottom ¾ section of the print head) jet ink as shown at the position S6 in FIG. 1. Then the print head steps a distance of HH/4 along the step direction and reaches the position S7 in the step direction. The head scans left and right along the scanning direction, and the head nozzles in shaded area (the bottom ½ section of the print head) jet ink when passing the to-be-printed image area. After coming back to the start edge in the scanning direction, the print head steps a distance of HH/4 again along the step direction and reaches the position S8 in the step direction. The print head scans left and right along the scanning direction, and the head nozzles in shaded area (the bottom ¼ section of the print head) jet ink when passing the to-be-printed image area. The whole to-be-printed image area will be printed through the procedure above. As FIG. 1 shows, for example, the height of the to-be-printed image area “H” is 125 mm, the print swath height of the print head “HH” is 100 mm, the scanning times are 4 (4 pass printing), and the distance for one step is SH=HH/Step=100/4=25 mm. The print head needs to step 8 times to print the whole to-be-printed image area.

When the height of the to-be-printed image area “H” is smaller than the total print swath height of one or more print heads(stitched) “HH”, taking increasing the desired print resolution to four times of the head resolution as an example, as shown in FIG. 2, for example, the height of the to-be-printed image area “H”=90 mm, the print swath height of the print head “HH”=100 mm, the scanning times are 4 (4 pass printing) and the distance for each step SH=HH/Step=100/4=25 mm. At the beginning of printing, the print head is at the position S01 in the step direction. The print head scans left and right along the scanning direction. During the unidirectional printing, the head nozzles in shaded area jet ink to generate image pattern when passing the to-be-printed image area. After coming back to the start edge in the scanning direction, the print head steps a distance of HH/4 along the step direction and arrives at the position S02 in the step direction. The print head scans left and right along the scanning direction. During the unidirectional printing, the head nozzles in shaded area jet ink to generate image pattern when passing the to-be-printed image area. After coming back to the start edge in the scanning direction, the print head steps a distance of HH/4 along the step direction and arrives at the position S03 in the step direction. The print head scans left and right along the scanning direction. During the unidirectional printing, the head nozzles in shaded area jet ink to generate image pattern when passing the to-be-printed image area. After coming back to the start edge in the scanning direction, the print head steps a distance of HH/4 along the step direction and arrives at the position S04 in the step direction. At this moment, the top of the print head is beyond the to-be-printed image area. The print head scans left and right along the scanning direction. During the unidirectional printing, the head nozzles in shaded area jet ink to generate image pattern when passing the to-be-printed image area. After coming back to the start edge in the scanning direction, the print head steps a distance of HH/4 along the step direction and arrives at the position S05 in the step direction. The print head scans left and right along the scanning direction. During the unidirectional printing, the head nozzles in shaded area jet ink to generate image pattern when passing the to-be-printed image area. After coming back to the start edge in the scanning direction, the print head steps a distance of HH/4 along the step direction and arrives at the position S06 in the step direction. And so on. When the print head steps at the last pass, which means the head is at the position S07 in the step direction, the print head scans left and right along the scanning direction, and nozzles in shaded area (less than the bottom ¼ section of the print head) jet ink when passing the to-be-printed image area. The whole to-be-printed image area will be printed through the above procedure. As FIG. 2 shows, the print head needs to step 7 times to print the whole to-be-printed image area. The general formula is: Total Step Times N=2*Steps−1 (“Steps” equals the said scanning times).

When the height of the to-be-printed image area “H” is smaller than the total print swath height of one or more print heads(stitched) “HH”, adopting the step times “2*Steps−1” will increase the stepping times, and lots of head nozzles don't jet ink at the beginning or end of the scan print movement. Thus that leads to needing more scanning times, increasing print time and lowering work efficiency.

### SUMMARY OF THE INVENTION

In view of the problems in the prior art, the purpose of the present invention is to provide with an inkjet printing method to reduce the print heads' scanning times, save printing time and costs, and improve the productive efficiency on the premise of ensuring the print precision.

To realize the purpose, the present invention presents an inkjet printing method, including the print heads' left and right scan movement along the scanning direction (X direction), the print heads' step movement along the step direction (Y direction), and the print heads' vertical movement perpendicular to the platen on which the to-be-printed object is placed (Z direction). The print heads jet ink during scanning movement for Bidirectional printing or Unidirectional printing; the print heads do not jet ink during step movement or vertical movement. Wherein, the step distance SH for print heads in the step movement is a tiny step SH distance, which satisfies SH≤(HH−H)/Steps (the calculation of “HH−H” divided by the number of Steps, the unit can be millimeter). Wherein HH represents the total print swath height of one or more print heads (stitched), H represents the height of the to-be-printed image area, and the Steps represents step times.

In the said inkjet printing method, wherein the step distance SH of the said print heads meets the formula: SH>(1/Print Head Resolution), in other words, SH>print head's nozzle pitch.

In the said inkjet printing method, wherein the height of the to-be-printed image area is smaller than the total print swath height of one or more print heads (stitched). The following Bidirectional printing steps are included:

Step 1, The top of one HH (one ink color) or multiple HHs arranged in parallel rows for multiple color printing align with the top edge of the to-be-printed image area;

Step 2, The print heads scan from the start edge to the end edge along the linear guide beam/the scanning direction, and at the same time the head nozzles are controlled to jet ink/image pattern on the object, then the print heads step a distance of SH along the step direction, and in this process don't jet ink;

Step 3, The print heads scan from the said end edge to the said start edge along the linear guide beam/the scanning direction, and at the same time the head nozzles are controlled to jet ink/image pattern to cover the ink drops attached to the said jetted ink/image pattern on the object in Step 2;

Step 4, The print heads step a distance of SH along the step direction/the direction perpendicular to the linear guide beam. In this process, print heads don't jet ink;

Step 5, Repeat Step 2, Step 3 and Step 4 until the end of printing (reach the number of steps depending on desired resolution).

In the said inkjet printing method, wherein the height of the to-be-printed image area is smaller than the total print swath height of one or more print heads (stitched). The following Unidirectional printing steps are included:

Step 1, The top of one HH (one ink color) or multiple HHs arranged in parallel rows for multiple color printing align with the top edge of the to-be-printed image area;

Step 2, The print heads scan from the start edge to the end edge along the linear guide beam/the scanning direction, and at the same time the head nozzles are controlled to jet ink/image pattern on the object;

Step 3, The print heads scan from the said end edge to the start edge along the linear guide beam/the scanning direction. In this process, print heads don't jet ink;

Step 4, The print heads step a distance of SH along the step direction/the direction perpendicular to the linear guide beam. In this process, print heads don't jet ink.

Step 5, Repeat Step 2, Step 3 and Step 4 until the end of printing (reach the number of steps depending on desired resolution).

In the said inkjet printing method, wherein the height of the to-be-printed image area is smaller than the total print swath height of one or more print heads (stitched). The following steps of 2.5D/3D printing are included:

Step 1, The top of one HH (one ink color) or multiple HHs arranged in parallel rows for multiple color printing align with the top edge of the to-be-printed image area;

Step 2, The print heads scan from the start edge to the end edge along the linear guide beam/the scanning direction, and at the same time the head nozzles are controlled to jet ink/image pattern on the object, then the print heads step a distance of SH along the step direction, and in this process don't jet ink;

Step 3, The print heads scan from the said end edge to the said start edge along the linear guide beam/the scanning direction, and at the same time the head nozzles are controlled to jet ink/image pattern to cover the ink drops attached to the said jetted ink/image pattern on the object in Step 2;

Step 4, The print heads step a distance of SH along the step direction/the direction perpendicular to the linear guide beam. In this process, print heads don't jet ink;

Step 5, Repeat Step 2, Step 3 and Step 4 until the end printing of one layer (reach the number of steps depending on desired resolution);

Step 6, Repeat Step 1, Step 2, Step 3, Step 4 and Step 5 until the printed image pattern reaches the expected thickness (that is, check if the thickness of the printed image pattern reaches the expected thickness, if not, repeat Step 1 to Step 5; if yes, continue to Step 7);

Step 7, Control the print heads to rise to the preset height in the direction perpendicular to the platen (Z direction);

Step 8, Repeat Step 1, Step 2, Step 3, Step 4, Step 5, Step 6 and Step 7 until the printed image pattern achieves the target height of 2.5D/3D print effect.

In the said inkjet printing method, wherein the height of the to-be-printed image area is larger than HH/the total print swath height of one or more print heads (stitched), the following steps are included:

Step 1, The top of one HH (one ink color) or multiple HHs arranged in parallel rows for multiple color printing align with the top edge of the to-be-printed image area, which is the print origin of the first section of the to-be-printed image area;

Step 2, The print heads scan from the start edge to the end edge along the linear guide beam/the scanning direction, and at the same time the head nozzles are controlled to jet ink/image pattern on the object, then the print heads step a distance of SH along the step direction, and in this process don't jet ink;

Step 3, The print heads scan from the said end edge to the said start edge along the linear guide beam/the scanning direction, and at the same time the head nozzles are controlled to jet ink/image pattern to cover the ink drops attached to the said jetted ink/image pattern on the object in Step 2;

Step 4, The print heads step a distance of SH along the step direction/the direction perpendicular to the linear guide beam. In this process, print heads don't jet ink;

Step 5, Repeat Step 2, Step 3 and Step 4 until the end printing of current section of the image area (reach the number of steps depending on desired resolution);

Step 6, Print Heads move to the print origin (Y direction) of the next section of the to-be-printed image area by stepping a big distance along the step direction (the big distance can be HH−(Steps−1)*SH);

Step 7, Repeat Step 2, Step 3 and Step 4 until the end printing of the current section of the image area (reach the number of steps depending on desired resolution);

Step 8, Repeat Step 6 and Step 7 until the whole to-be-printed image area is printed.

In the said inkjet printing method, wherein includes before printing, adjusting the distance between the nozzle plane in the carriage and the object to a distance suitable for printing.

The method in this invention is well-thought designed. When users need to print high-resolution image pattern but use the relatively low-resolution print heads, this method enables to reduce the total step times of the print heads and improves the utilization ratio of head nozzles. Thus, on the premise of guaranteeing the high-resolution, the print time is shortened and the print efficiency is improved.

### BRIEF DESCRIPTION OF THE DRAWINGS

FIG. 1 is a diagram of one print head (one ink color) step printing method with the present technology.

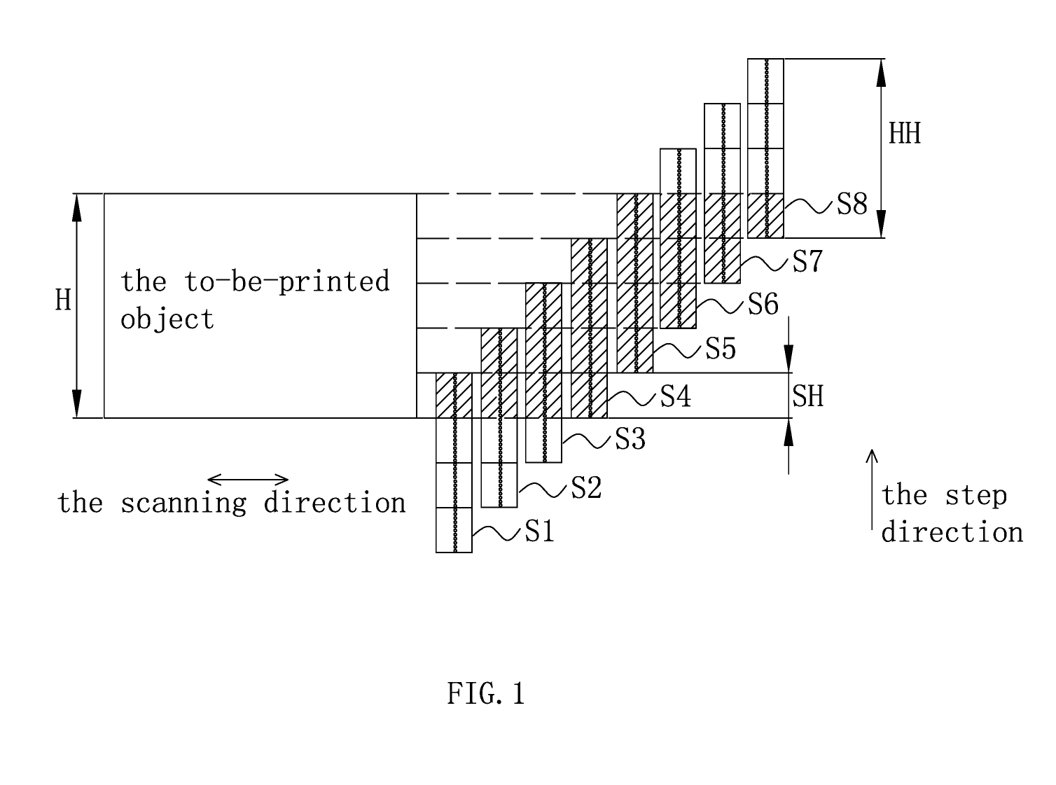

FIG. 2 is a diagram of one print head (one ink color) step printing method with the present technology in the other case.

FIG. 3 is a diagram of one print head (one ink color) step printing method in this invention.

FIG. 4 is a diagram of multiple print heads (stitched) at the beginning position of printing in another embodiment.

FIG. 5 is a diagram of multiple print heads arranged in parallel rows for multiple color ink step printing method to print multiple sections of one larger image.

FIG. 6 is a diagram of one print head (one ink color) step printing method when the height of the to-be-printed image area is larger than the print swath height of one print head (one ink color) in another embodiment.

### DETAILED DESCRIPTION OF THE EMBODIMENT

Preferred embodiments of the inkjet printing method in this invention is descried but not confined below with reference to the accompanying figures.

The inkjet printing method in this invention is based on an inkjet printing apparatus, which includes a printing carriage, a linear guide beam, a platen to lay the object for printing, a to-be-printed object and a control system. The linear guide beam is mounted along the print heads' scanning direction (X direction). The printing carriage is mounted on the linear guide beam, and the printing carriage moves left and right (or right and left) along the linear guide beam. One or more print heads can be mounted at the bottom of the carriage. When only one print head is mounted (one ink color), the color of output ink depends on the print image pattern requirement. When multiple print heads are mounted, the print heads can either jet different colors of ink such as Magenta (M), Yellow (Y), Cyan (C) and Black (K), or jet the same color of ink to increase the print speed. In addition, at least one print head for printing white ink (W) and/or transparent ink (V) can be mounted on the printing carriage in this invention. The sub-ink-tank and negative pressure control system can be also added to the carriage. The carriage not only moves left and right along the linear guide beam/the scanning direction, but also moves along the step direction (Y direction) which is perpendicular to the scanning direction/the linear guide beam. Moreover, it can also move along the vertical direction perpendicular to the platen on which the to-be-printed object is placed (Z direction). The platen mounted below the linear guide beam is used to hold the to-be-printed object. In this invention, the to-be-printed image area is usually smaller than the total print swath height of one or more print heads (stitched). It can be also larger than the total print swath height of one or more print heads (stitched). The control system controls the print heads to scan left and right along the scanning direction and jet ink during the scanning process with bidirectional or unidirectional printing method. It also controls the print heads to step along the step direction and move along vertical direction perpendicular to the platen on which the to-be-printed object is placed.

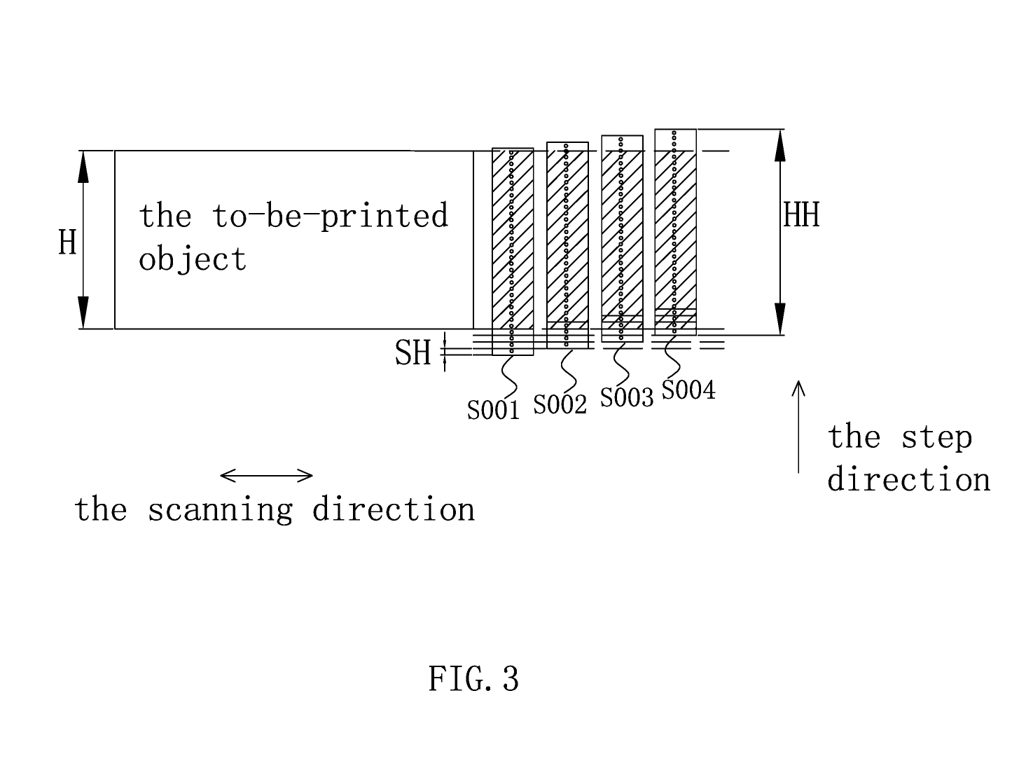

The example shown in FIG. 3 is an embodiment of this invention. The height of the to-be-printed object/image area is represented by H, and the total print swath height of one or more print heads (stitched) is represented by HH. When only one head (one ink color) is used for printing, the height of this head is HH; when multiple heads are stitched for printing (also one ink color) in order to lengthen the nozzles coverage, the height of all stitched print heads is HH. The step times of the print heads is represented by Steps/Step. The step distance of the print heads SH each time is tiny and much smaller than the step distance of the traditional printing method—“HH” divided by the number of steps. Meanwhile, the step distance SH is smaller or equal to the calculation of “(HH−H)/Steps” (the calculation of “HH−H” divided by the number of Steps), and the step distance SH should be larger than 1/Print Head Resolution, in other words, SH should be larger than the print head's nozzle pitch. The unit can be millimeter or inch.

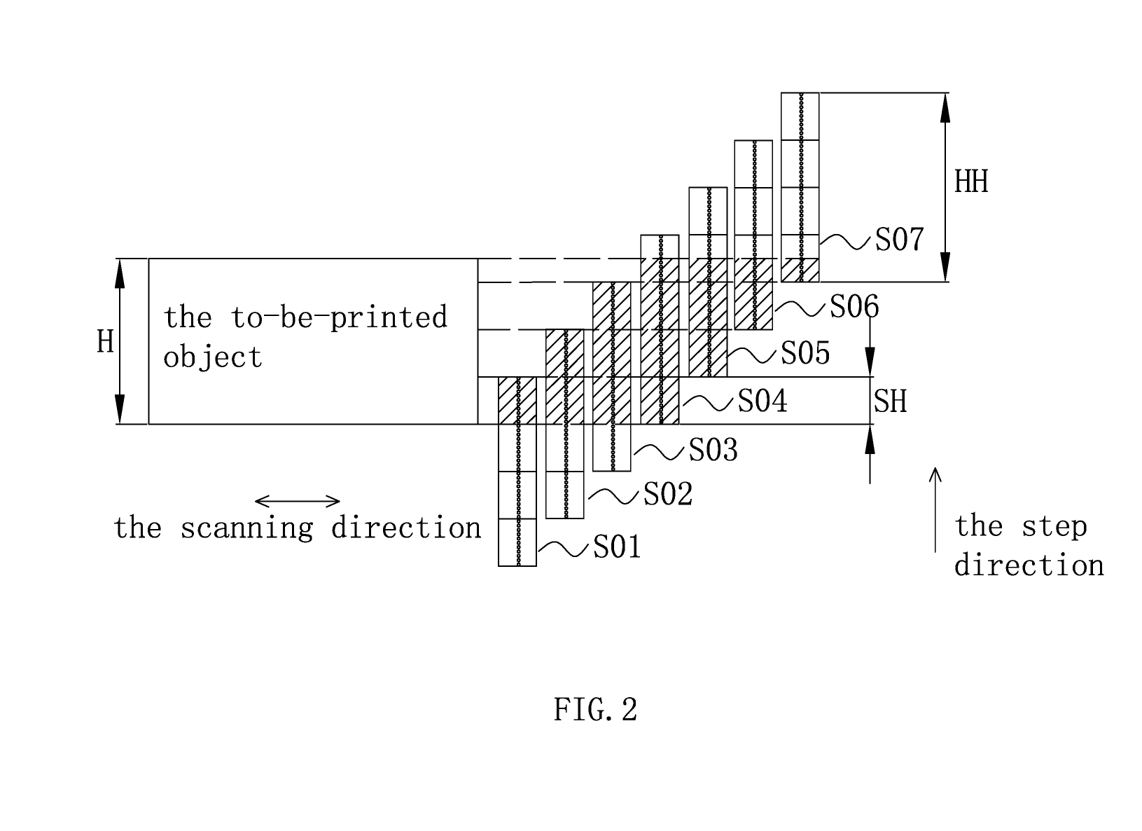

The detailed printing process for this print method is: At the beginning of printing, the print head is at the position S001 in the step direction. The top of one HH (one ink color)/the print head's first nozzle aligns with the top edge of the to-be-printed image area. The print head scans left and right along the scanning direction/the linear guide beam (scans from the start edge to the end edge, and then scans from the said end edge to the said start edge). During the unidirectional printing, the head nozzles in shaded area jet ink to generate image pattern, which means the head nozzles right above the to-be-printed image area jet ink/image pattern, and others don't jet ink. After coming back to the start edge in the scanning direction, the print head steps a distance of SH along the step direction and arrives at the position S002 in the step direction. The print head scans left and right again along the scanning direction. During the unidirectional printing, the head nozzles in shaded area jet ink to generate image pattern, which means the head nozzles right above the to-be-printed image area jet ink/image pattern, and others don't jet ink. After coming back to the start edge in the scanning direction, the print head steps a distance of SH along the step direction and arrives at the position S003 in the step direction. The print head scans left and right again along the scanning direction. During the unidirectional printing, the head nozzles in shaded area jet ink to generate image pattern, which means the head nozzles right above the to-be-printed area jet ink/image pattern, and others don't jet ink. After coming back to the start edge in the scanning direction, the print head steps a distance of SH along the step direction and arrives at the position S004. The print head scans left and right again along the scanning direction. During the unidirectional printing, the head nozzles in shaded area jet ink to generate image pattern, which means the head nozzles right above the to-be-printed area jet ink/image pattern, and others don't jet ink. After coming back to the start edge in the scanning direction, the whole to-be-printed image area is printed. If the print head prints with the bidirectional printing method, the print head scans back(left) and forth(right) two times in total along the scanning direction, and the print head steps a distance of SH along the step direction before the per next scan printing. Through the said printing method above, the image pattern on the to-be-printed object has been printed four times and the resolution is four times of the head resolution. In this print method, the print head needs to scan print four times to print the whole to-be-printed image area. In other words, the desired resolution divided by the head resolution equals the number of step times. Moreover, the total step times N is equal to the number of step times: N=Steps. This method is different from the present print method indicated in FIG. 2: Total step times=2*Steps−1.

Take the following detailed parameters as an example to illustrate FIG. 3: The height of the to-be-printed image area H=90 mm, the total print swath height of the print head HH=100 mm, the head resolution is 300 dpi, and the desired resolution of the to-be-printed image pattern should be 1200 dpi. Therefore the step times “Steps” is 1200 dpi/300 dpi=4, which means the print head needs to scan print and step four times to finish the print of the whole to-be-printed image area. The step distance SH meets the formula: ( 1/300 dpi*25.4) mm<Step Distance “SH”≤(the total print swath height of the print head HH “100 mm”−the height of the to-be-printed image area H “90 mm”)/Step Times “4”. The general formula is (1÷Print Head Resolution*25.4)<Step Distance “SH”≤(HH−H)÷Steps, the unit can be millimeter. When the unit is inch, (1÷Print Head Resolution)<Step Distance “SH”. In other words, SH>print head's nozzle pitch.

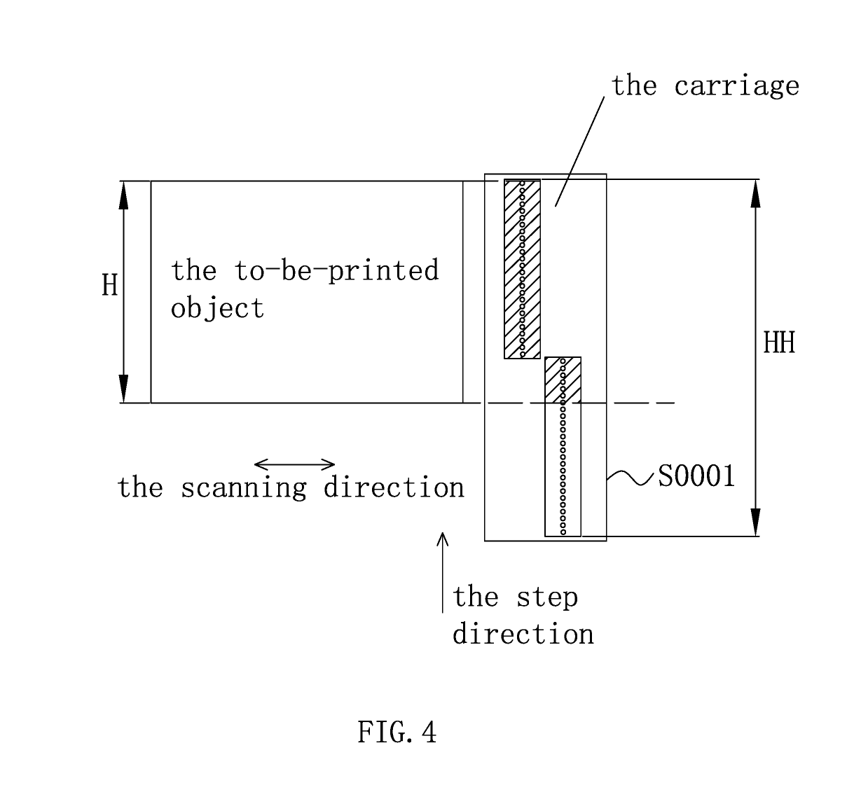

FIG. 4 is a diagram of the print heads at the beginning position of printing in another embodiment. Different from the embodiment in FIG. 3, multiple print heads are mounted on the carriage and they are stitched (linked end-to-end). In this case, in order to increase the print height in the left and right scan print process, the total print swath height of multiple print heads “HH” is the total height of the two heads stitched as shown in the image. The scan print and step movement method is the same with those in FIG. 3.

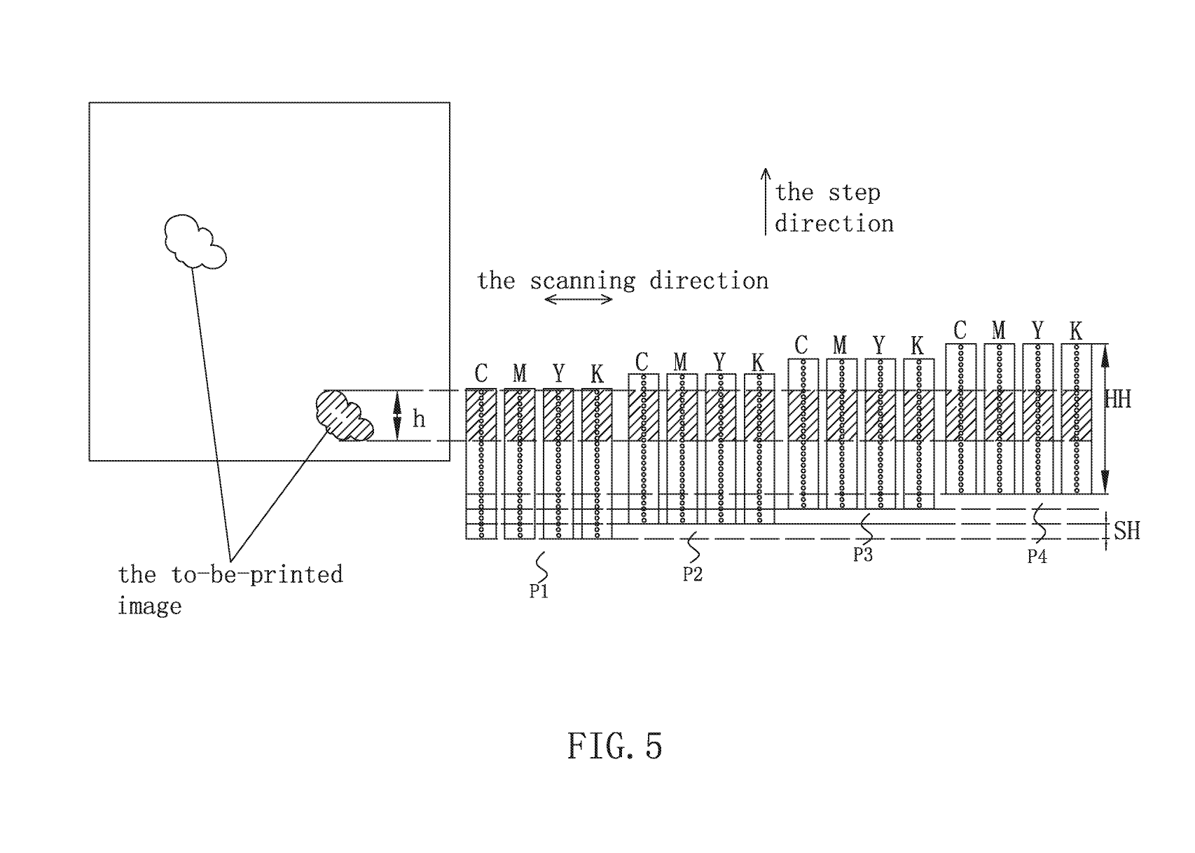

FIG. 5 is a diagram of multiple print heads arranged in parallel rows for multiple color ink step printing method to print multiple sections of one larger image. When printing with flatbed printer, one larger image including some small sections needs to be printed on the media. The sections are far from each other and the height of each to-be-printed section pattern “h” is smaller than the total swath height of the print head “HH”. In this case, the above print method can be still adopted. The embodiment is used for multiple color printing, wherein four print heads arranged in parallel rows which jet four different colors of ink Magenta, Yellow, Cyan and Black are mounted on the carriage. “Steps” represents the step times of print heads and “SH” represents the tiny step distance of the print heads each time. SH is a tiny distance and is smaller or equal to the calculation of [(the total print swath height of the print heads “HH”−the height of each to-be-printed small sized section “h”)÷Steps], the unit can be millimeter. Meanwhile, “SH” should be bigger than (1/Head Resolution*25.4) mm or (1/Head Resolution) inch. In other words, SH>print head's nozzle pitch.

The detailed printing process of this printing method is similar to the said method of FIG. 3. At the beginning of printing, the four color print heads are at the position P1 in the step direction. The top of four HHs arranged in parallel rows (each print head's first nozzle) align with the top edge of the first to-be-printed section area. The print heads scans left and right along the scanning direction and print image pattern with the Unidirectional printing method. The scanning scope in the scanning direction may only cover the first to-be-printed section area. During the unidirectional printing, the head nozzles in shaded area jet ink to generate image pattern, which means the head nozzles right above the first to-be-printed section area jet ink, and others don't jet ink. After coming back to the start edge in the scanning direction, the print heads step a distance of SH along the step direction and arrive at the position P2 in the step direction. The print heads scan left and right again along the scanning direction. The scanning scope in the scanning direction only covers the first to-be-printed section area. During the unidirectional printing, the head nozzles in shaded area jet ink to generate image pattern when passing the first to-be-printed section area, which means the head nozzles right above the first to-be-printed section area jet ink, and others don't jet ink. After coming back to the start edge in the scanning direction, the print heads step a distance of SH along the step direction and arrive at the position P3 in the step direction. The print heads scan left and right again along the scanning direction. The scanning scope in the scanning direction only covers the first to-be-printed section area. During the unidirectional printing, the head nozzles in shaded area jet ink to generate image pattern when passing the first to-be-printed section area, which means the head nozzles right above the first to-be-printed section area jet ink, and others don't jet ink. After coming back to the start edge in the scanning direction, the print heads step a distance of SH again along the step direction and arrive at the position P4 in the step direction. The print heads scan left and right again along the scanning direction. The scanning scope in the scanning direction only covers the first to-be-printed section area. During the unidirectional printing, the head nozzles in shaded area jet ink to generate image pattern when passing the first to-be-printed section area, which means the head nozzles right above the first to-be-printed section area jet ink, and others don't jet ink. After coming back to the start edge in the scanning direction, this section of the to-be-printed image area (the first to-be-printed section) is printed. The image pattern of the first to-be-printed section is printed by four times and the image pattern resolution is four times of head resolution. In this printing method, the print heads need to scan four times to print the first to-be-printed section area. The desired resolution divided by the head resolution equals the number of step times. That is, the total step times for printing the first section area “N” equals the number of step times “Steps”: N=Steps. This method is different from the present print method indicated in FIG. 2: Total step times=2*Steps−1. After printing the first to-be-printed section area, the control system controls the carriage to step a big distance along the step direction until the top of four print heads arranged in parallel rows aligns with the top edge of the second to-be-printed section area. The carriage moves to the start edge of the second to-be-printed section area along the scanning direction. The following print method is the same with the above print method of printing the first section area: The print heads scan left and right along the scanning direction and print image pattern with the Unidirectional printing method, and step a distance of SH along the step direction before each scan printing with the same method as printing at the positions P1 to P4 in the step direction. In this printing method, there may be multiple to-be-printed section areas on the media. Adopting this print method decreases the step times of the print heads, saves the print time and improves the print efficiency.

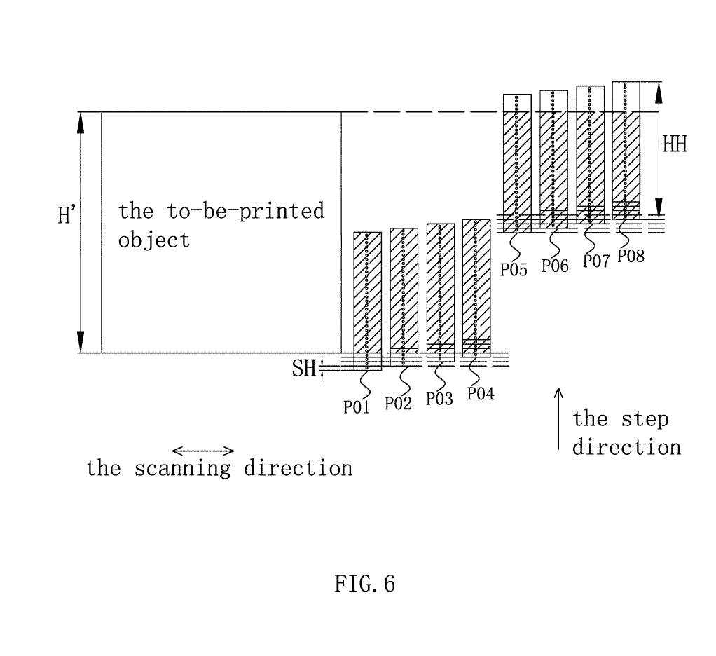

FIG. 6 is a diagram of one print head step printing method when the height of the to-be-printed image area is larger than the print swath height of one print head in another embodiment. The said step method can be still used when the height of the to-be-printed image area “H” is larger than the total print swath height of one or more print heads(stitched) “HH”. The step distance of the print head contains a tiny distance and a big distance. Take four Pass printing as an example. The beginning of this printing method is similar to the method shown in FIG. 3: At the beginning of printing, the print head is at the position P01 in the step direction, that is, the top of one HH (one ink color)/the print head's first nozzle aligns with the print origin of the first section of the to-be-printed image area. The print head scans left and right along the scanning direction and print image pattern with the Unidirectional Printing method. During the unidirectional printing, the head nozzles in shaded area jet ink to generate image pattern, which means the head nozzles right above the to-be-printed image area jet ink/image pattern, and others don't jet ink. After coming back to the start edge in the scanning direction, the print head steps a distance of SH along the step direction and arrives at the position P02 in the step direction. The print head scans left and right again along the scanning direction. During the unidirectional printing, the head nozzles in shaded area jet ink to generate image pattern, which means the head nozzles right above the to-be-printed image area jet ink/image pattern, and others don't jet ink. After coming back to the start edge in the scanning direction, the print head steps a distance of SH again along the step direction and arrives at the position P03 in the step direction. The print head scans left and right again along the scanning direction. During the unidirectional printing, the head nozzles in shaded area jet ink to generate image pattern, which means the head nozzles right above the to-be-printed image area jet ink/image pattern, and others don't jet ink. After coming back to the start edge in the scanning direction, the print head steps a distance of SH again along the step direction and arrives at the position P04 in the step direction. The print head scans left and right again along the scanning direction. During the unidirectional printing, the head nozzles in shaded area jet ink to generate image pattern, which means the head nozzles right above the to-be-printed image area jet ink/image pattern, and others don't jet ink. After coming back to the start edge in the scanning direction, the current section of the image area is printed, then the print head steps a big distance of (HH−3*SH) along the step direction and arrives at the position P05 in the step direction [the big distance is HH−(steps−1)*SH]. The print head scans left and right again along the scanning direction. During the unidirectional printing, the head nozzles in shaded area jet ink to generate image pattern, which means the head nozzles right above the to-be-printed image area jet ink/image pattern, and others don't jet ink. After coming back to the start edge in the scanning direction, the print head steps a distance of SH along the step direction and arrives at the position P06 in the step direction. The print head scans left and right again along the scanning direction. During the unidirectional printing, the head nozzles in shaded area jet ink to generate image pattern, which means the head nozzles right above the to-be-printed image area jet ink/image pattern, and others don't jet ink. After coming back to the start edge in the scanning direction, the print head steps a distance of SH along the step direction and arrives at the position P07 in the step direction. The print head scans left and right again along the scanning direction. During the unidirectional printing, the head nozzles in shaded area jet ink to generate image pattern, which means the head nozzles right above the to-be-printed image area jet ink/image pattern, and others don't jet ink. After coming back to the start edge in the scanning direction, the print head steps a distance of SH along the step direction and arrives at the position P08 in the step direction. The print head scans left and right again along the scanning direction. During the unidirectional printing, the head nozzles in shaded area jet ink to generate image pattern, which means the head nozzles right above the to-be-printed image area jet ink/image pattern, and others don't jet ink. After coming back to the start edge in the scanning direction, the whole to-be-printed image area in this example is printed. The image pattern in the to-be-printed image area has been printed for four times and the desired resolution is four times of the head resolution. In conclusion, the print method can be also used when the height of the to-be-printed image area “H” is larger than the total print swath height of one or more print heads(stitched) “HH”.

In short, when the height of the to-be-printed image area “H” is larger than the total print swath height of one or more print heads(stitched) “HH”, every time after the print head steps a distance of SH along the step direction for desired step times which depend on desired resolution (defined as tiny step cycle), then the print head steps a big distance of [HH−(steps−1)*SH] along the step direction and continue repeating the said print method of the tiny step cycle. In the said method, print until the whole to-be-printed image area is printed. The desired high-resolution print effect can be achieved without affecting the print efficiency.

In addition, the above print method can be used when the carriage moves along vertical direction perpendicular to the platen on which the to-be-printed object is placed (Z direction), to print the image pattern with 3D or 2.5D print effect. After printing one layer of the to-be-printed image with the above printing method, the print head scans left and right to print the same image by repeating the above printing method. After the overlapped images reach the expected thickness, this moment, need to check if the thickness of the printed image pattern reaches the expected thickness, if not, repeat the above print and step method; if yes, the carriage will rise for a micro distance to the preset height along the direction perpendicular to the platen (Z direction) on which the to-be-printed object is placed and repeat the above operations until the printed image pattern overlapped achieves the target height 2.5D/3D print effect. The detailed printing procedure is: Step 1, The top of HH (one print head for one ink color) or multiple HHs (multiple print heads) arranged in parallel rows for multiple color printing align with the top of the to-be-printed image area; Step 2, The print heads scan from the start edge to the end edge along the liner guide beam (the scanning direction), and at the same time the head nozzles are controlled to jet ink/image pattern on the object, then the print heads step a distance of SH along the step direction, and in this process don't jet ink; Step 3, The print heads scan from the said end edge to the said start edge along the linear guide beam (the scanning direction), and at the same time the head nozzles are controlled to jet ink/image pattern to cover the ink drops attached to the said jetted ink/image pattern on the object in Step 2; Step 4, The print heads step a distance of SH along the step direction/the direction perpendicular to the linear guide beam. In this process, the print heads don't jet ink; Step 5, Repeat Step 2, Step 3 and Step 4 until the end printing of one layer (reach the number of steps depending on desired resolution); Step 6, Repeat Step 1, Step 2, Step 3, Step 4 and Step 5 until the printed image reaches to the expected thickness (that is, check if the thickness of the printed image reaches the expected thickness, if not, repeat Step 1 to Step 5; if yes, continue to Step 7); Step 7, Control the print heads to rise to the preset height in the direction perpendicular to the platen (Z direction); Step 8, Repeat Step 1, Step 2, Step 3, Step 4, Step 5, Step 6 and Step 7 until the printed image achieves the target height of 2.5D/3D print effect. The above scan printing method is bidirectional printing method, in addition to this, we can also use the unidirectional printing method along the scanning direction and step a distance of SH along the step direction before each scan printing, and other processes are the same as above.

In addition, the present printing method includes before printing, adjusting the distance between the nozzle plane in the carriage and the object to a distance suitable for printing in Z direction.

The present printing method in this invention enables to reduce the total step times of the print heads and improve the utilization ratio of the head nozzles. Thus, on the premise of guaranteeing the high-resolution, the print time is shortened and the print efficiency is improved.

It is to be understood that any alternations and modifications made to the detailed embodiment herein shall not depart from the scope of the claims and spirit of the present invention.

What is claimed is:

1. An inkjet printing method, wherein includes the print heads' left and right scan movement along the scanning direction (X direction), the print heads' step movement along the step direction (Y direction), and the print heads' vertical movement perpendicular to the platen on which the to-be-printed object is placed (Z direction); the print heads jet ink during scanning movement for Bidirectional printing or Unidirectional printing; the print heads do not jet ink during step movement or vertical movement; the characteristic is, the step distance SH of the print heads in the step movement is a tiny step SH distance, which satisfies SH≤(HH−H)/Steps (the calculation of “HH−H” divided by the number of Steps, the unit can be millimeter), wherein HH represents the total print swath height of one or more print heads(stitched), H represents the height of the to-be-printed image area, and the Steps represents step times.

2. The inkjet printing method according to claim 1, wherein the step distance SH of the said print heads meets the formula: SH>(1/Print Head Resolution), in other words, SH>print head's nozzle pitch.

3. The inkjet printing method according to claim 1, wherein the height of the to-be-printed image area is smaller than the total print swath height of one or more print heads (stitched); the following Bidirectional printing steps are included:
Step 1, The top of one HH (one ink color) or multiple HHs arranged in parallel rows for multiple color printing align with the top edge of the to-be-printed image area;
Step 2, The print heads scan from the start edge to the end edge along the linear guide beam/the scanning direction, and at the same time the head nozzles are controlled to jet ink/image pattern on the object, then the print heads step a distance of SH along the step direction, and in this process don't jet ink;
Step 3, The print heads scan from the said end edge to the said start edge along the linear guide beam/the scanning direction, and at the same time the head nozzles are controlled to jet ink/image pattern to cover the ink drops attached to the said jetted ink/image pattern on the object in Step 2;
Step 4, The print heads step a distance of SH along the step direction/the direction perpendicular to the linear guide beam, and in this process don't jet ink;
Step 5, Repeat Step 2, Step 3 and Step 4 until the end of printing (reach the number of steps depending on desired resolution).

4. The inkjet printing method according to claim 1, wherein the height of the to-be-printed image area is smaller than the total print swath height of one or more print heads (stitched); the following Unidirectional printing steps are included:
Step 1, The top of one HH (one ink color) or multiple HHs arranged in parallel rows for multiple color printing align with the top edge of the to-be-printed image area;
Step 2, The print heads scan from the start edge to the end edge along the linear guide beam/the scanning direction, and at the same time the head nozzles are controlled to jet ink/image pattern on the object;
Step 3, The print heads scan from the said end edge to the said start edge along the linear guide beam/the scanning direction, and in this process don't jet ink;
Step 4, The print heads step a distance of SH along the step direction/the direction perpendicular to the linear guide beam, and in this process don't jet ink;
Step 5, Repeat Step 2, Step 3 and Step 4 until the end of printing (reach the number of steps depending on desired resolution).

5. The inkjet printing method according to claim 1, wherein the height of the to-be-printed image area is smaller than the total print swath height of one or more print heads (stitched); the following steps of 2.5D/3D printing are included:
Step 1, The top of one HH (one ink color) or multiple HHs arranged in parallel rows for multiple color printing align with the top edge of the to-be-printed image area;
Step 2, The print heads scan from the start edge to the end edge along the linear guide beam/the scanning direction, and at the same time the head nozzles are controlled to jet ink/image pattern on the object, then the print heads step a distance of SH along the step direction, and in this process don't jet ink;
Step 3, The print heads scan from the said end edge to the said start edge along the linear guide beam/the scanning direction, and at the same time the head nozzles are controlled to jet ink/image pattern to cover the ink drops attached to the said jetted ink/image pattern on the object in Step 2;
Step 4, The print heads step a distance of SH along the step direction/the direction perpendicular to the linear guide beam, and in this process don't jet ink;
Step 5, Repeat Step 2, Step 3 and Step 4 until the end printing of one layer (reach the number of steps depending on desired resolution);
Step 6, Repeat Step 1, Step 2, Step 3, Step 4 and Step 5 until the printed image pattern reaches the expected thickness (that is, check if the thickness of the printed image pattern reaches the expected thickness, if not, repeat Step 1 to Step 5; if yes, continue to Step 7);
Step 7, Control the print heads to rise to the preset height in the direction perpendicular to the platen (Z direction);
Step 8, Repeat Step 1, Step 2, Step 3, Step 4, Step 5, Step 6 and Step 7 until the printed image pattern achieves the target height of 2.5D/3D print effect.

6. The inkjet printing method according to claim 1, the height of the to-be-printed image area is larger than HH, wherein the following steps are included:
Step 1, The top of one HH (one ink color) or multiple HHs arranged in parallel rows for multiple color printing align with the top edge of the to-be-printed image area, which is the print origin of the first section of the to-be-printed image area;
Step 2, The print heads scan from the start edge to the end edge along the linear guide beam/the scanning direction, and at the same time the head nozzles are controlled to jet ink/image pattern on the object, then the print heads step a distance of SH along the step direction, and in this process don't jet ink;
Step 3, The print heads scan from the said end edge to the said start edge along the linear guide beam/the scanning direction, and at the same time the head nozzles are controlled to jet ink/image pattern to cover the ink drops attached to the said jetted ink/image pattern on the object in Step 2;
Step 4, The print heads step a distance of SH along the step direction/the direction perpendicular to the linear guide beam, and in this process don't jet ink;
Step 5, Repeat Step 2, Step 3 and Step 4 until the end printing of the current section of the image area(reach the number of steps depending on desired resolution);
Step 6, The print heads move to the print origin (Y direction) of the next section of the to-be-printed image area by stepping a big distance along the step direction (the big distance can be HH−(Steps−1)*SH);
Step 7, Repeat Step 2, Step 3 and Step 4 until the end printing of the current section of the image area (reach the number of steps depending on desired resolution);
Step 8, Repeat Step 6 and Step 7 until the whole to-be-printed image area is printed.

7. The inkjet printing method according to claim 1, wherein includes before printing, adjusting the distance between the nozzle plane in the carriage and the object to a distance suitable for printing.
